(19) United States
(12) Patent Application Publication
(10) Pub. No.: US 2016/0028726 A1
(43) Pub. Date: Jan. 28, 2016

(54) Device to Device User Service Sharing Using Shared Trusted ID

(71) Applicant: SONY CORPORATION, Minato-ku, Tokyo (JP)

(72) Inventors: Benjamin Jan MATTHEWS, Helsingborg (SE); Eskil AAHLIN, San Mateo, CA (US)

(21) Appl. No.: 14/417,838

(22) PCT Filed: Jan. 28, 2014
(86) PCT No.: PCT/JP2014/000426

§ 371 Date: Jan. 28, 2015

(51) Int. Cl. H04L 29/06

(52) U.S. Cl. CPC H04L 63/0869; H04L 63/083; H04L 63/105

(57) ABSTRACT

Sharing a service with a trusted device is described. User login information is received from a user, including a trusted device id associated with the device and the user. A detection broadcast is received from another device and a response message is sent to the other device indicating the device is also associated with the trusted device id. Authentication is performed to determine that the user has successfully logged into the other device with the user login information associated with the trusted device id. Information about services available on the device may be sent to the other device. A service may be selected and performed with data and service instructions received from the other device. The selected service on the device may require a user to be logged in and the selected service may not be available on the other device.

### TECHNICAL FIELD

Embodiments of the present invention relate to electronic devices, wireless communication and application services.

### BACKGROUND ART

Many electronic devices may be useful but have hardware limitations or limited functionality. For example, such devices may have limited computing power, a limited user interface, no 3G/4G capability or a rather small physical memory. Despite the hardware limitations, for these devices to be more useful, they have to be versatile and enable the user to utilize many services, including secure services that are available online or in the cloud.

### SUMMARY

Various embodiments described herein provide for trusted pairing between electronic devices such that one device may use services available on the other device. Once a user has logged into each device separately with a trusted device id, the devices may be paired when they detect each other based on the trusted user id without further user interaction.

According to some embodiments, an electronic device for trusted service sharing may include a processor and a memory coupled to the processor. The memory may include computer readable program code embodied in the memory that when executed by the processor causes the processor to perform operations. The operation may include receiving user login information from a user comprising a trusted device id associated with the user. The trusted device id may also be already associated with the device. The operations may include sending a response message to another device indicating the device is also associated with the trusted device id responsive to detecting a broadcast from the other device determined to be associated with the trusted device id. In some cases, an outgoing detection broadcast associated with the trusted device id may also be sent by the first device. The operations may further include authenticating the trusted device id shared between the device and the other device to determine that the user has successfully logged into the other device with the user login information associated with the trusted device id and sending service information to the other device responsive to a positive authentication. The service information may include services available on the device for use by the other device. The operations may also include performing a service selected from the available services with data received from the other device based on service instructions corresponding to the service. The selected service on the device may require a user to be logged in with user service credentials different than the user login information. In some cases, the selected service may not require the user to be logged in with user service credentials. The available services on the device may not be available on the other device.

According to some embodiments, responsive to the positive authentication, the user service credentials associated with the trusted device id for the service on the device may be received.

According to some embodiments, the service on the device may be automatically logged into with the received user service credentials without receiving further input from the user prior to performing the service on the device.

According to some embodiments, service information may be sent to the other device without further input from the user after sending the response message. Service information associated with the available services may be displayed on a display of the other device. A service key may be sent to the other device for authentication by the device of the service instructions received from the other device.

According to some embodiments, the user service credentials associated with the trusted device id for the service on the device may be sent to a second other device responsive to a positive authentication of the trusted device id shared with the second other device.

According to some embodiments, an electronic device for trusted service sharing may include a processor and a memory coupled to the processor. The memory may include computer readable program code embodied in the memory that when executed by the processor causes the processor to perform operations. The operations may include receiving user login information from a user comprising a trusted device id associated with the user and sending a detection broadcast indicating the device is associated with the trusted device id. The operations may further comprise authenticating the trusted device id shared between the device and another device, responsive to receiving a response message from the other device determined to be associated with the trusted device id, to determine that the user has successfully logged into the other device with the user login information associated with the trusted device id. The operations may also include receiving service information from the other device responsive to a positive authentication. The service information may include services available on the other device for use by the device. The operations may further include selecting a service among the available services and sending data and service instructions corresponding to the selected service. The selected service may be performed with the received data on the other device based on the service instructions. The selected service on the device may require a user to be logged in with user service credentials different than the user login information, and the user service credentials may not be stored on or received by the device. The available services on the device may not be available on the other device.

According to some embodiments, the service information may be received from the other device without further input from the user after sending the detection broadcast. A representation of the available services may be displayed on a display of the device.

According to some embodiments, a service key may be received from the other device to send with the service instructions for authentication of the service instructions by the other device.

According to some embodiments, a method for sharing services between first and second electronic devices may include receiving, by the first device, user login information from a user comprising a trusted device id associated with the user and, responsive to detecting a broadcast from the second device determined to be associated with the trusted device id, sending a response message to the second device indicating the first device is also associated with the trusted device id. The method may also include authenticating the trusted device id shared between the first device and the second device to determine that the user has successfully logged into the second device with the user login information associated with the trusted device id. The method may further include, responsive to a positive authentication, sending service information to the second device. The service information may include services available on the first device for use by the second device. The method may also include, responsive to receiving data and service instructions from the second device corresponding to a service selected from the available services, performing the selected service with the received data on the first device based on the service instructions. The selected service on the first device may require a user to be logged in with user service credentials different than the user login information. The available services on the first device may not be available on the second device. In some cases, service information may be sent based on services not available or discovered to not be available on the second device.

According to some embodiments, the method may further include, prior to performing the service on the first device, automatically logging into the service on the first device with the received user service credentials without receiving further input from the user.

According to some embodiments, the method may include sending the service information to the second device without further input from the user after sending the response message.

According to some embodiments, the method may further include receiving, by the second device, the user login information from the user comprising the trusted device id associated with the user and sending, by the second device, a detection broadcast after the receiving the user login information by the second device, indicating the second device is associated with the trusted device id. The method may include, responsive to receiving a response message from the first device determined to be associated with the trusted device id, authenticating, by the second device, the trusted device id shared between the first and second devices to determine that the user has successfully logged into the first device with the user login information associated with the trusted device id. The method may also include, responsive to a positive authentication, receiving, by the second device, service information from the first device. The service information may include services available on the first device for use by the second device.

According to some embodiments, the method may further include selecting a service among the available services and sending, by the second device, data and service instructions corresponding to the selected service. The selected service may be performed with the received data on the first device based on the service instructions. The selected service on the first device may require a user to be logged in with user service credentials different than the user login information. The user service credentials may not be stored on or received by the second device. The method may include receiving the service information from the first device without further input from the user at the second device after sending the detection broadcast.

Other devices, methods, and/or computer program products according to embodiments of the invention will be or become apparent to one with skill in the art upon review of the following drawings and detailed description. It is intended that all such additional devices, methods, and/or computer program products be included within this description, be within the scope of the present invention, and be protected by the accompanying claims. Moreover, it is intended that all embodiments disclosed herein can be implemented separately or combined in any way and/or combination.

### BRIEF DESCRIPTION OF DRAWINGS

The accompanying drawings, which are included to provide a further understanding of the invention and are incorporated in and constitute a part of this application, illustrate certain embodiment(s) of the invention.

FIG. 1 illustrates a user logging into first and second electronic devices, respectively, according to various embodiments of the present invention.

FIG. 2 illustrates a user logging into first and second electronic devices, respectively, according to various embodiments of the present invention.

FIG. 3 is a schematic block diagram of the first electronic device, according to various embodiments.

FIG. 4 is a schematic block diagram of the second electronic device, according to various embodiments.

FIG. 5 is a flowchart illustrating a process for the first electronic device sharing a service with the second device, according to various embodiments.

FIG. 6 is a flowchart illustrating a process for the second electronic device using a service of the first device, according to various embodiments.

FIG. 7 illustrates the first electronic device sharing a service with the second electronic device, according to various embodiments.

FIG. 8 illustrates the first electronic device sharing a service with the second electronic device, according to various embodiments.

FIG. 9 illustrates the first electronic device sharing a service with the second electronic device, according to various embodiments.

FIG. 10 illustrates the first electronic device sharing a service with the second electronic device, according to various embodiments.

FIG. 11 illustrates the first electronic device sharing a service with the second electronic device, according to various embodiments.

FIG. 12 illustrates the first electronic device sharing a service with the second electronic device, according to various embodiments.

FIG. 13 illustrates the first electronic device receiving user service credentials, according to various embodiments.

FIG. 14 illustrates the first electronic device sharing user service credentials with another trusted device, according to various embodiments.

### DESCRIPTION OF EMBODIMENTS

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof. As used herein, the term “and/or” includes any and all combinations of one or more of the associated listed items. Furthermore, as used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this disclosure and the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

Despite any hardware limitations, electronic devices may need to provide a user access to a number of services. Such services may include online services and services that require user registration and/or a secure user login with user service credentials. Unfortunately, these services may not be properly supported by limited devices. However, more capable devices may offer their services to these more limited devices. In some cases, a more capable device may serve as a proxy device or hub service device for a more limited device. In some cases, a limited device may be a more capable device with respect to other devices or services. The embodiments described herein provide for a seamless sharing of services between trusted devices.

A more capable device may allow a limited device to access certain services of the capable device. For example, a limited device, such as a smartwatch, may only use Bluetooth&reg; low energy (BLE) protocols, near field communication (NFC) protocols or Wi-Fi protocols, and may only have a camera or sensor. The limited device can take advantage of a secure file storage service through a more capable device, such as a smartphone with internet access and an application on the smartphone that manages access to the secure file storage service. Use of the service may involve a different communication protocol than the detection, pairing and/or the service information communications. In an example, Bluetooth (registered trademark) low energy (BLE) protocols may be used for detection, Wi-Fi communication protocols may be used for large file transfer and Bluetooth&reg; protocols may be used for small data transfer.

The secure file storage service may require a username and password or other service credentials from the user. The limited device will not require the user to enter the service user credentials. The limited device will rely on a trusted user id that indicates ownership of the devices by the user. Both the limited device and the capable device may be owned by the user and share a trusted device id between them. This trusted device id may be provided by a manufacturer, service provider or other entity capable of offering a level of trust between devices. The trusted device id may be shared among devices of a defined family or type that are owned by the user. For example, all devices manufactured by Sony Corporation and owned by the user may share a secure and unique trusted device id.

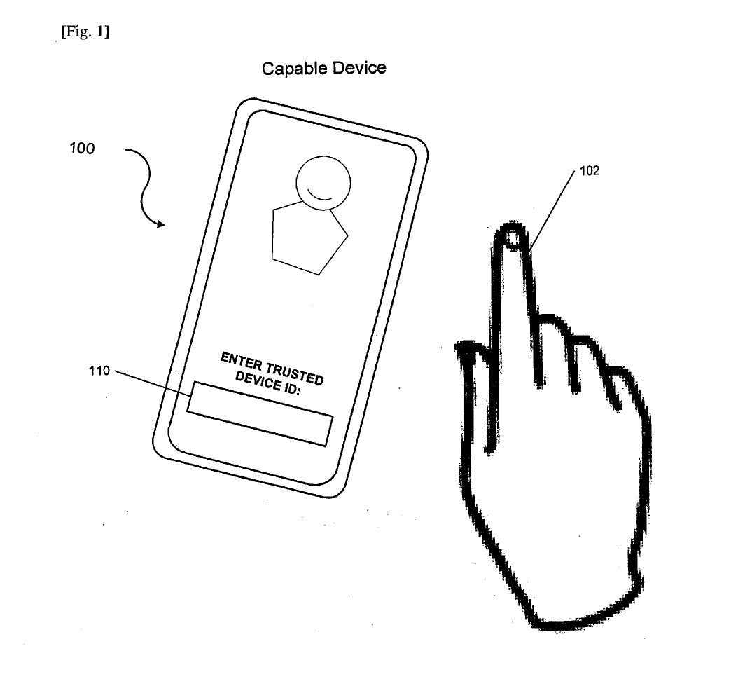

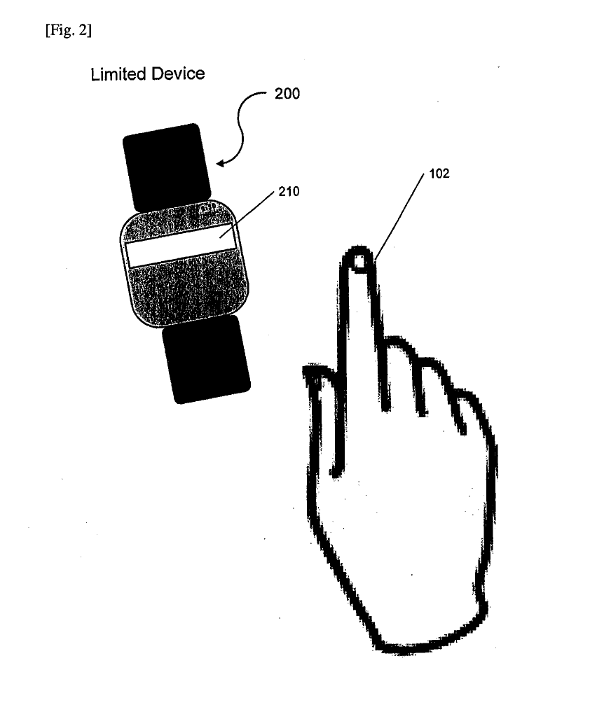

The user may log into each device individually with this trusted device id. For example, FIG. 1 illustrates a user logging into a capable device 100, according to some embodiments. The user 102 enters user login information that includes a trusted device id. In some cases, the user 102 enters the trusted device id at a location 110 on device 100 with a password, pin or other authentication information. In other cases, the user 102 enters a username previously registered with the trusted device id rather than the trusted device id itself. In FIG. 2, the user 102 enters the same user login information associated with the trusted id into location 210 of a second, more limited device 200. In some cases, the user login information may be different but may still be associated with the same trusted device id.

In some embodiments, user login mechanisms may include biometric data, like fingerprint or retina scans. That biometric data may then be associated with the user in a capable device so that mutual authentication can be performed. If the limited device has an internet connection, then a username/password scheme may be used, or a one-time password token could be sent via SMS to a capable device that is trusted. That one-time password token could then be entered into the limited device, upon which the limited device can download the trusted id from a server.

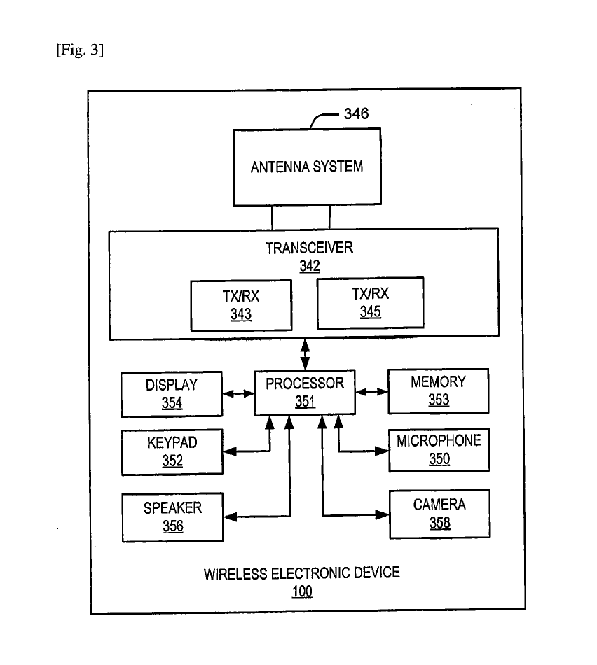

Device 100 may be a smartphone and include computing device and communication components shown in FIG. 3. FIG. 3 is a schematic block diagram of wireless electronic device 100, according to various embodiments. Device 100 may be a mobile terminal but is not limited to a mobile terminal. Device 100 may communicate with a wireless local network, the internet or other devices using a communication protocol that may include, but is not limited to, IEEE 802.11a, 802.11b, 802.11g, 802.11n, 802.11ac, and/or other wireless local area network protocols.

In some embodiments of the invention, the device 100 includes various components, such as a processor 351, an antenna system 346, a cellular and/or Wi-Fi transceiver 342 (e.g., multi-band with transceivers 343 and 345), a memory 353, display 354, keypad 352, speaker 356, microphone 350 and/or camera 350. Some embodiments provide that the display 354 may include a touch sensitive display or screen, or the like.

The memory 353 stores software that may be executed by the processor 351, and may include one or more erasable programmable read-only memories (EPROM or Flash EPROM), battery backed random access memory (RAM), magnetic, optical, or other digital storage device, and may be separate from, or at least partially within, the processor 351. The processor 351 may include more than one processor, such as, for example, a general purpose processor and a digital signal processor, which may be enclosed in a common package or separate and apart from one another. In particular, the processor 351 may be configured to control various functions of the device 100, including receiving input from a touch sensitive screen or other sensors.

Device 100 may communicate with a base station of a network using radio frequency signals, which may be communicated through antenna system 346. For example, device 100 may be configured to communicate via the cellular transceiver 342 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS), among others. Communication protocols as used herein may specify the information communicated, the timing, the frequency, the modulation, and/or the operations for setting-up and/or maintaining a communication connection. In some embodiments, the antenna system 346 may be a single antenna.

It is to be understood that the present invention is not limited to the particular configurations shown in FIG. 3, but is intended to encompass any configuration capable of carrying out operations described herein. While particular functionalities are shown in particular blocks by way of illustration, functionalities of different blocks and/or portions thereof may be combined, divided, and/or eliminated. Moreover, the functionality of the hardware/software architecture may be implemented as a single processor system or a multi-processor system in accordance with various embodiments of the present invention.

Embodiments of the present invention may include methods, electronic devices, and/or computer program products. Some embodiments of the present invention are described with reference to block diagrams and/or operational illustrations of methods and electronic devices. In this regard, each block may represent a module, segment, or portion of code, which comprises one or more executable instructions for implementing the specified logical function(s). It is to be understood that each block of the block diagrams and/or operational illustrations, and combinations of blocks in the block diagrams and/or operational illustrations can be embodied on analog circuitry and/or digital circuitry. These program instructions may be provided to a controller circuit, which may include one or more general purpose processors, special purpose processors, ASICs, and/or other programmable data processing apparatus, such that the instructions, which execute via the controller, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

These computer program instructions may also be stored in a computer-usable or computer-readable memory that may direct a controller circuit to function in a particular manner, such that the instructions stored in the computer usable or computer-readable memory produce an article of manufacture including instructions that implement the function specified in the flowchart and/or block diagram block or blocks. The computer-usable or computer-readable medium may be, for example but not limited to, an electronic, magnetic, optical, electromagnetic, or semiconductor system, apparatus, or device. More specific examples (a nonexhaustive list) of the computer-readable medium include the following: hard disk devices, optical storage devices, magnetic storage devices, random access memory (RAM) devices, read-only memory (ROM) devices, erasable programmable read-only memory (EPROM or Flash memory) devices, and compact disc read-only memory (CD-ROM).

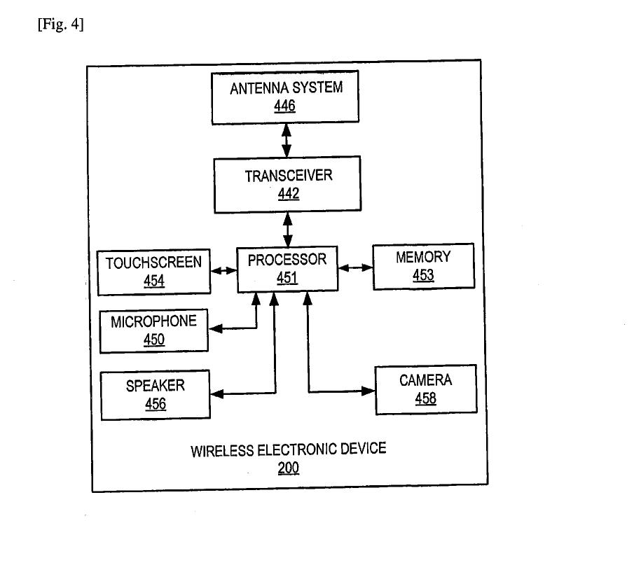

FIG. 4 is a schematic block diagram of a more limited device 200, according to various embodiments. Device 200 may have an antenna system 446, transceiver 442, processor 451, memory 453, touchscreen 454 (display/keypad), microphone 450, speaker 456 and camera 458. Device 200 and its components may operate as described above for device 100. However, device 200 may be more limited in hardware, software and/or functionality. For example, transceiver 442 and antenna system 446 may be configured for Wi-Fi or low energy systems, but may not be configured for cellular communication. Also, in some cases, device 200 may not be capable of accessing the internet or online application services.

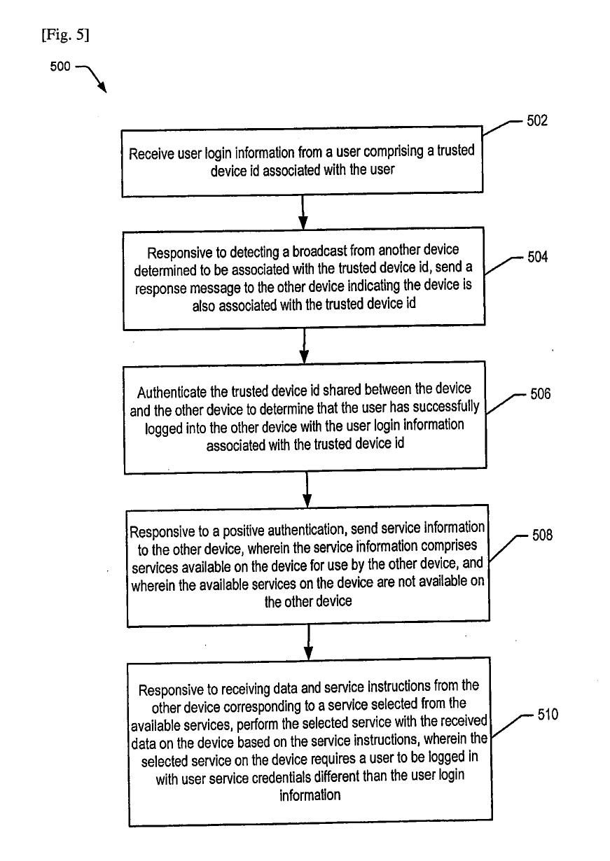

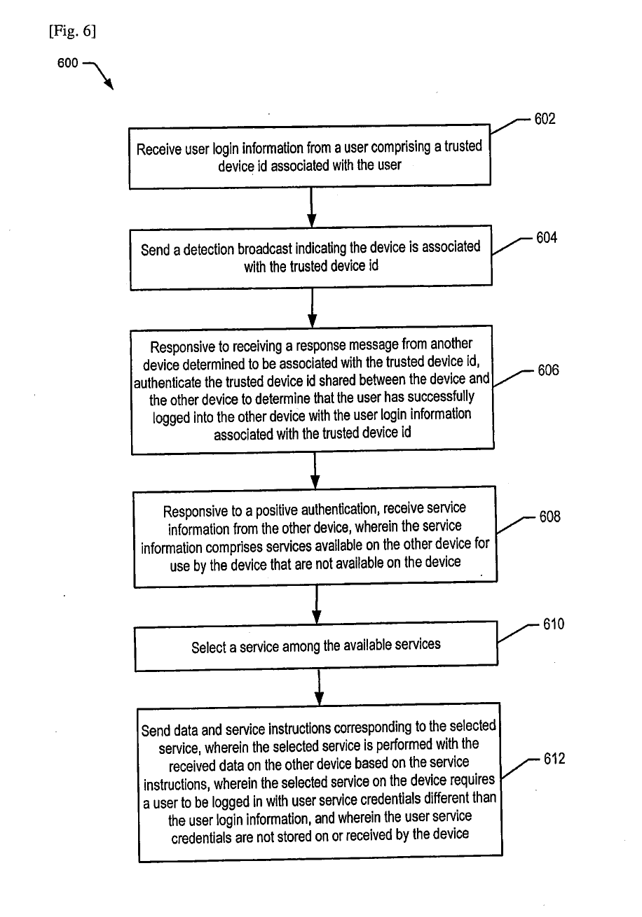

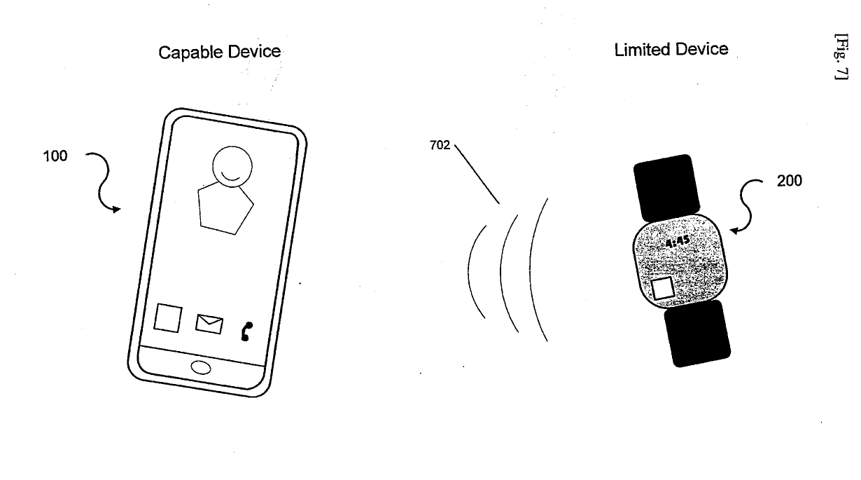

According to some embodiments, FIGS. 7-12 will be described with reference to flowchart 500 in FIG. 5 and flowchart 600 in FIG. 6. As described above in FIGS. 1 and 2, the user 102 may login into device 100 (block 502) and device 200 (block 602) with user login information associated with the trusted device id. The devices 100 and 200 may receive the user login information from the user 102, the user login information including a trusted device id (blocks 502 and 602). The trusted device id may be associated with the user 102. The trusted device id may be used to associate device 100 or 200 to the user 102. In some cases, device 100 or 200 may already be associated with the trusted device id before login. The devices 100 and 200 may be in separate locations and may not be aware of each other.

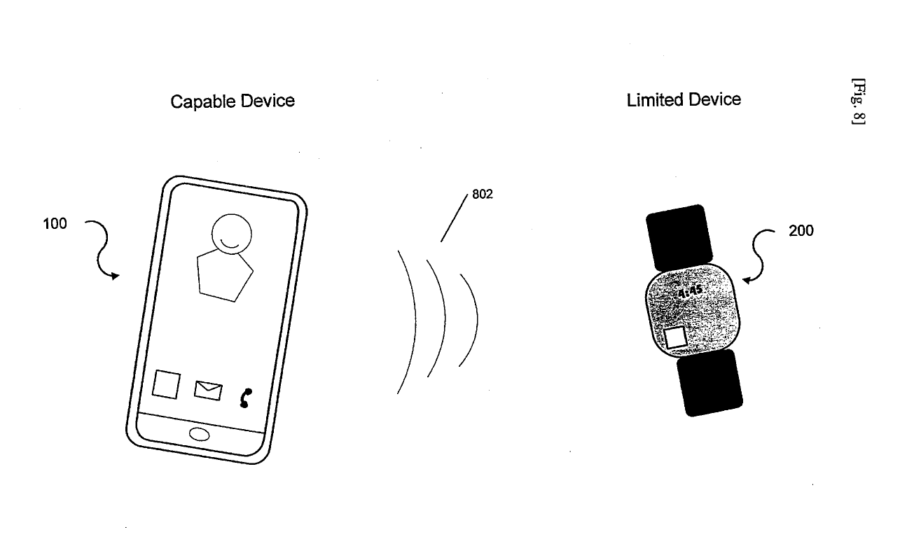

When the devices 100 and 200 come into proximity with each other, such as user 102 wearing watch device 102 and walking into the living room where the smartphone device 100 is located, the devices may detect one another and pair together based on the trusted user id. To do so, each device may send broadcast messages identifying the device or information associated with a trusted device id. For example, as shown in FIG. 7, device 200 may send a detection broadcast 702 indicating that device 200 is associated with a certain entity, service provider, affiliation, manufacturer, product family, company or organization. For example, the detection broadcast 702 may indicate that the device 200 is associated with a specific manufacturer and/or service provider product family. A device family may be a defined group of devices from any combination of one or more manufacturers and/or service providers. A type may be, for example, defined as all smartphones or as all laptops and tablets of the one or more manufacturers and/or service providers. In some cases, the broadcast 702 may include the trusted device id (block 604), which may be specific and unique. Device 100 may detect this broadcast from device 200 and determine that device 200 is associated with the same device family/type, device grouping or trusted device id as that of device 100 (block 504). In response, device 100 may send a response message 802 indicating it is also associated with the same device family/type or trusted device id as that of device 200, as shown in FIG. 8. In some cases, the response message may only be that it is of the same family/type and a subsequent message communicates the trusted device id.

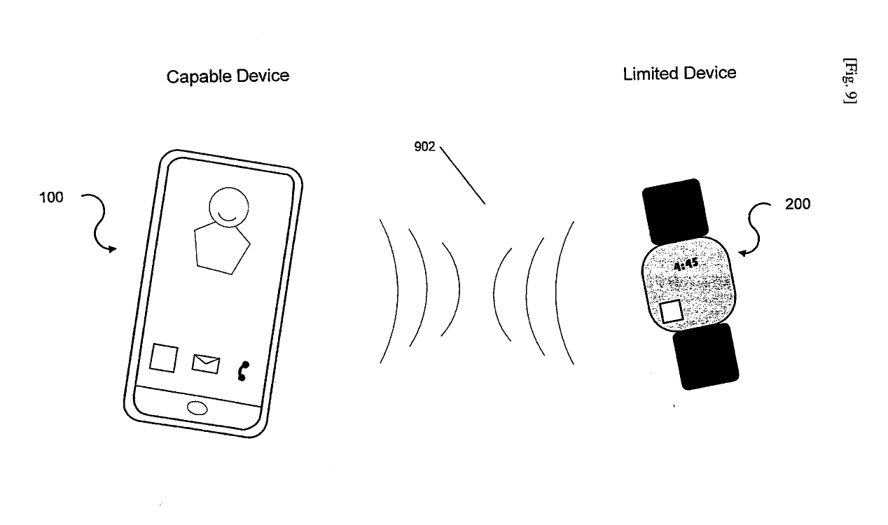

As shown in FIG. 9, devices 100 and 200 may authenticate the trusted device id received from each other to determine that the user 102 has logged into the other device with the same user login information associated with the trusted device id (blocks 506 and 606). This may involve further authentication information 902, such as the use of public and/or private certificates that each device received upon a first login with the user login information. The certificates and/or any certifications, keys or challenge/response information may have been received from or verified with a trusted device id server. However, after user 102 has logged into each device, contact with the trusted server may no longer be necessary for authentication of the trusted service id as each device may store and/or share certificate information and use the information for authentication. This authentication and pairing may be performed with or without any other user input or approval by the user after the user login of blocks 502 and 602. In many embodiments, pairing based on the trusted device id may be performed in isolation of any other devices, servers or services.

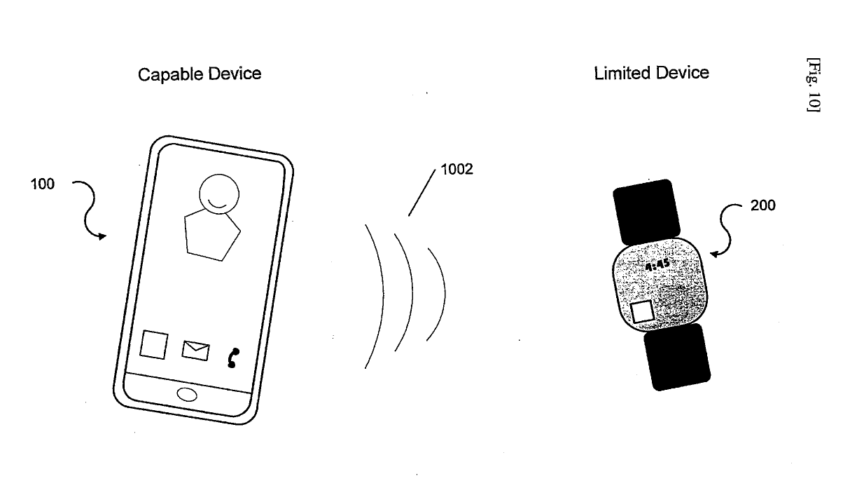

As shown in FIG. 10, device 100 may send service information 1002 that includes what services are available on device 100 for use by device 200 (block 508). These available services on device 100 may not be available on device 200. This may be in response to a positive authentication. Device 100 may or may not know services are available on the limited device and may just send information about the services that device 100 is capable of sharing. Such services may require user 102 to login or otherwise provide user service credentials to access the service. For example, the secure online file storage service may involve an application on device 100 that requires user service credentials. The services available may vary based on the user 102, the accounts of the user, the profile of the user, information about device 200 received by device 100, or information about device 200 that is stored in a table on device 100.

Device 200 may receive this service information indicating services available on device 100 (block 608). Device 200 may have an expectation of what services it may be offered. In some cases, device 200 may expect services based on categories of service (e.g., online storage, internet access, image processing, specification applications, etc.).

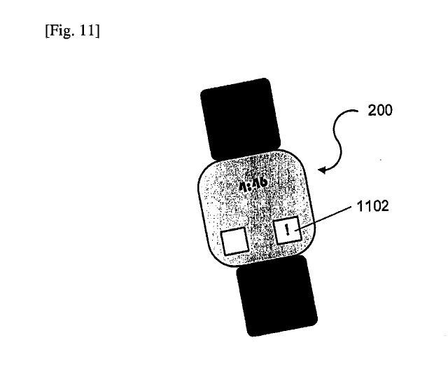

A service may be selected (block 610). This may be a selection by user 102. The user 102 may be made aware of services by an indication on device 200. For example, a representation, such as a new icon 1102 shown in FIG. 11, may appear indicating a new service available to user 102. This may allow user 102 to make a choice between services or the choice to utilize the service. The user may or may not be made aware that the new service exists because of the proximity of device 100.

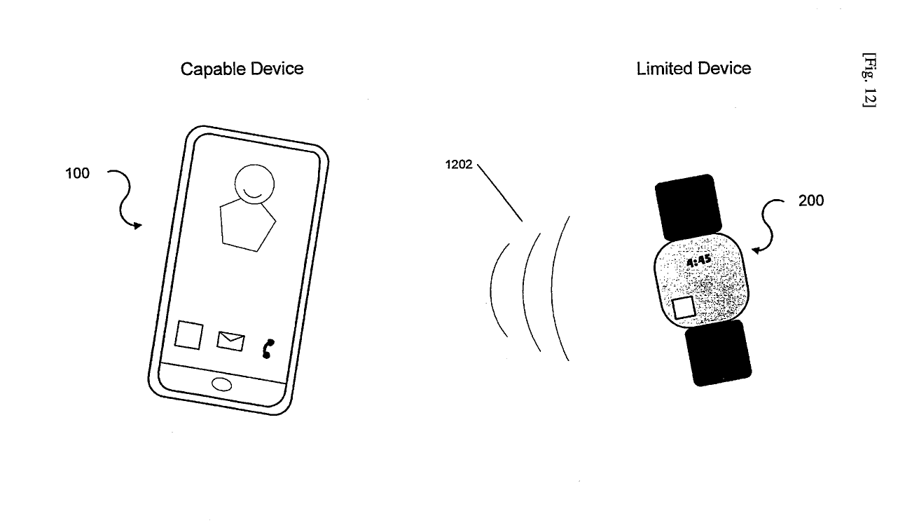

In some embodiments, the selection of block 610 may be made by the device 200 without further user input. The user 102 may have device 200 configured to perform certain functions automatically when paired with another capable, trusted device. As shown in FIG. 12, message 1202 may be sent to device 100 (block 612). This message 1202 may include data that may be a file, a communication, sensor information, status information or any other information that will be used by or for a selected service available on device 100. In some cases, message 1202 may also include service instructions that will inform device 100 and the selected service on device 100 what action to perform with the data. In other cases, device 100 will automatically know what to do with the data when it is received.

Upon receipt of the data and corresponding service instructions in message 1202, device 100 will perform the selected service (block 510). The service may require user service credentials of the service to perform the service. For example, the user may already be logged in with the user service credentials and the service will proceed without further input from the user. In some cases, the service may require or await a user login upon receiving the selected service data and instructions. In other cases, user service credentials may not be needed. For example, the service could be a roaming interne connection.

In various cases, a user, having logged into separate devices 100 and 200, will not need to provide any more input until the service is to be selected or until data is to be captured by device 200 or prepared for transmission to device 100 due to user interaction with device 200 based on the purpose of device 200. For example, device 200 may record some health vitals of the user, ambient temperature readings, GPS readings, images, texts, audio, video, etc. This may involve user interaction. In some cases, the service may be offered, selected and performed independent of and without any other user input beyond the initial logging into the devices 100 and 200.

In an example, device 200 may be a digital camera that takes pictures but does not have access to an online picture album with a secure login. When digital camera comes into proximity with device 100, which may be a laptop that shares a trusted device id, the laptop indicates to the digital camera that is can upload the pictures to the secure photo album. Whether the user selects the service or whether the service is utilized automatically, the images may be sent to the laptop and then uploaded into the secure photo album, utilizing the user service credentials entered from the laptop for the photo album service.

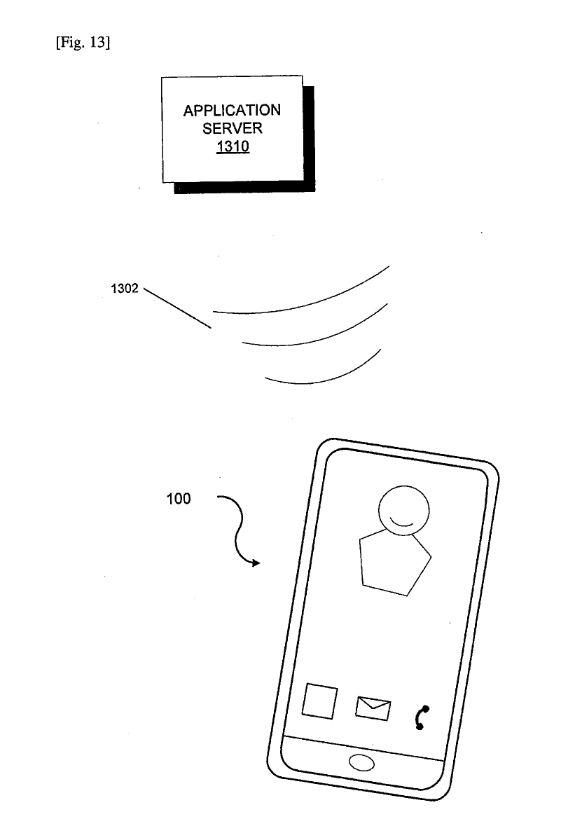

In some embodiments, user service credentials may be received from a third entity, such as an application server 1310 in FIG. 13, based on the fact that the device is confirmed to be logging in with the trusted device id. User service credentials for services may be stored in association with the trusted device id such that they may be provided to devices that also share the same trusted device id.

In a further example, a third device may come into proximity with a laptop. If it is determined that the third device (e.g., tablet) has the same trusted device id as the laptop by way of the same user login information (also owned by the user), any user service credentials for the secure photo album may be passed onto the tablet. User service credentials may be shared based on its association with the same trusted device id. The tablet, having not previously been logged into the secure photo album, may receive the user service credentials from the laptop upon pairing with the laptop. In some cases, this may be managed by a user account associated with the trusted user id. Having the capability to log into the photo album service, the laptop does so and communicates this to a more limited device, such as the digital camera. The digital camera, having authenticated the trusted device id of the tablet, receives information from the tablet that it can provide the online photo album service. The digital camera proceeds to send images to the tablet, which store the images using the secure online photo album services. In some embodiments, multiple devices of the user, which share the same trusted device id, may act as one device to provide the services.

In some embodiments, once a pairing is made for the first time, future proximity overlaps between the devices may result in fewer authentication or service offering steps, that information already being stored by the devices after the first pairing.

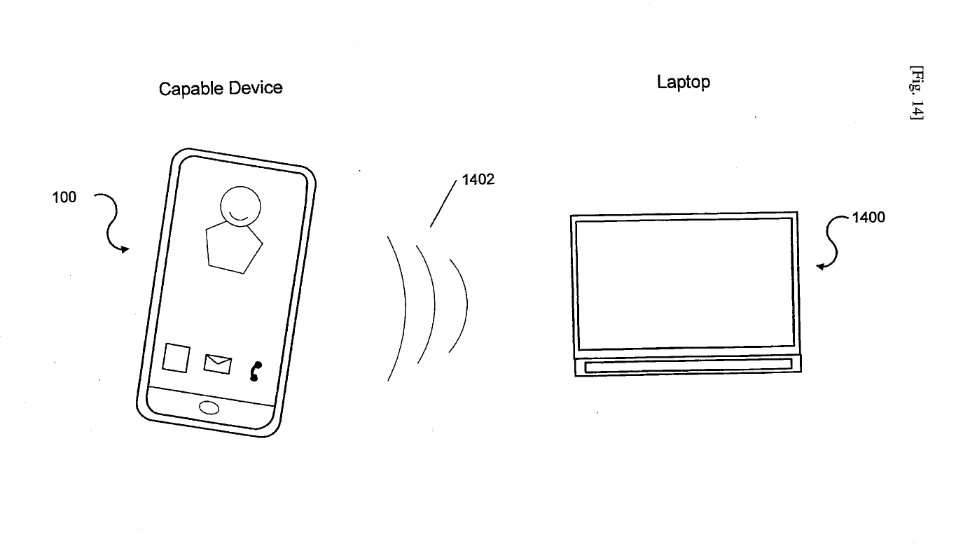

In another example, smartphone 100 roaming in a foreign country may come into proximity with a trusted device, such as a laptop 1400 with internet access, as shown in FIG. 14. Smartphone 100 is a more limited device than capable laptop 1400. The user had logged into each device with the trusted device id. In this example, the user returns from dinner, carrying his smartphone 100, but leaving the laptop 1400 in his hotel room. The smartphone 100 sends a detection broadcast 1402, which is detected by laptop 1400. Without user input, and perhaps upon expectation of the user, the smartphone 100 and the laptop 1400 perform a trusted and secure pairing, the smartphone 100 learns of the laptop's 1400 ability to access the internet, and then uses the internet service of the laptop 1400 to update its email and social media data in a seamless fashion without incurring roaming charges. The smartphone 100 is otherwise unable to use the internet in this location and does not have any information about the user service credentials the laptop 1400 uses to access the internet. These user service credentials may be different than the user login information used by the user to log into the devices in association with the trusted device id. In some cases, extra icons, status information and/or service confirmations may appear on the smartphone 100 for information purposes.

This process contrasts with existing methods where the user has to affirmatively connect the smartphone to the laptop without any overall relationship between the user's devices. In the embodiments described herein, a trust relationship is formed between the owner's devices as it becomes knows through the trusted device id that the same user owns the devices, so that various devices of the owner can use the services that require user service credentials and that may exist on other devices, whether they are more capable or less capable. This provides for more refined use of advanced and secure applications, the offered services being on the user plane.

Many different embodiments have been disclosed herein and different applications/variations will be apparent to a skilled person having knowledge of the present disclosure. In the drawings and specification, there have been disclosed typical embodiments of the invention and, although specific terms are employed, they are used in a generic and descriptive sense only and not for purposes of limitation, the scope of the invention being set forth in the following claims. It would be understood that it would be unduly repetitious and obfuscating to literally describe and illustrate every combination and subcombination of these embodiments. Accordingly, the present specification, including the drawings, shall be construed to constitute a complete written description of all combination and subcombinations of the embodiments of the present invention described herein, and of the manner and process of making and using them, and shall support claims to any such combination or subcombination.

In the specification, there have been disclosed embodiments of the invention and, although specific terms are employed, they are used in a generic and descriptive sense only and not for purposes of limitation.

1. An electronic device for trusted device service sharing, comprising:
a processor; and
a memory coupled to the processor and comprising computer readable program code embodied in the memory that when executed by the processor causes the processor to perform operations comprising:
receiving user login information from a user comprising a trusted device id associated with the user;
responsive to detecting a broadcast from another device associated with the trusted device id, sending a response message to the other device indicating the device is associated with the trusted device id;
mutually authenticating the trusted device id shared between the device and the other device to determine that the user has successfully logged into the other device with the user login information associated with the trusted device id and to provide authentication to the other device that the user has successfully logged into the device with the user information associated with the trusted device id;
responsive to a positive authentication, sending service information to the other device, wherein the service information comprises services available on the device for use by the other device; and
responsive to receiving data and service instructions from the other device corresponding to a service selected from the available services, performing the selected service with the received data on the device based on the service instructions.

2. The electronic device of claim 1, wherein the available services on the device are not available on the other device.

3. The electronic device of claim 1, wherein the selected service on the device requires a user to be logged in with user service credentials different than the user login information, and wherein the user service credentials are not stored on or received by the device.

4. The electronic device of claim 3, wherein the operations further comprise:
responsive to the positive authentication, receiving the user service credentials associated with the trusted device id for the service on the device; and
prior to performing the service on the device, logging into the service on the device with the received user service credentials without receiving further input from the user.

5. The electronic device of claim 3, wherein the operations further comprise:
sending the user service credentials associated with the trusted device id for the service on the device to a second other device responsive to a positive authentication of the trusted device id shared with the second other device.

6. The electronic device of claim 1, wherein the sending service information to the other device comprises sending the service information to the other device without further input from the user after sending the response message.

7. The electronic device of claim 1, wherein the sending service information to the other device comprises sending display information associated with the available services to the other device for display on a display of the other device.

8. The electronic device of claim 1, wherein the sending service information to the other device comprises sending a service key to the other device for authentication by the device of the service instructions received from the other device.

9. An electronic device for trusted device service sharing, comprising:
a processor; and
a memory coupled to the processor and comprising computer readable program code embodied in the memory that when executed by the processor causes the processor to perform operations comprising:
receiving user login information from a user comprising a trusted device id associated with the user;
sending a detection broadcast indicating the device is associated with the trusted device id;
responsive to receiving a response message from another device determined to be associated with the trusted device id, mutually authenticating the trusted device id shared between the device and the other device to determine that the user has successfully logged into the other device with the user login information associated with the trusted device id and to provide authentication to the other device that the user has successfully logged into the device with the user information associated with the trusted device id;
responsive to a positive authentication, receiving service information from the other device, wherein the service information comprises services available on the other device for use by the device;
selecting a service among the available services; and
sending data and service instructions corresponding to the selected service, wherein the selected service is performed with the received data on the other device based on the service instructions, wherein the selected service on the device requires a user to be logged in with user service credentials different than the user login information, and wherein the user service credentials are not stored on or received by the device.

10. The electronic device of claim 9, wherein the available services on the other device are not available on the device.

11. The electronic device of claim 9, wherein the receiving service information from the other device comprises receiving the service information from the other device without further input from the user after sending the detection broadcast.

12. The electronic device of claim 9, wherein the operations further comprise:
displaying a representation of the available services on a display of the device.

13. The electronic device of claim 9, wherein the receiving service information from the other device comprises receiving a service key from the other device to send with the service instructions for authentication of the service instructions.

14. A method for sharing services between first and second electronic devices, comprising:
receiving, by the first device, user login information from a user comprising a trusted device id associated with the user;
responsive to detecting a broadcast from the second device associated with the trusted device id, sending a response message to the second device indicating the first device is also-associated with the trusted device id;
mutually authenticating the trusted device id shared between the first device and the second device to determine that the user has successfully logged into the second device with the user login information associated with the trusted device id and to provide authentication to the other device that the user has successfully logged into the device with the user information associated with the trusted device id;
responsive to a positive authentication, sending service information to the second device, wherein the service information comprises services available on the first device for use by the second device; and
responsive to receiving data and service instructions from the second device corresponding to a service selected from the available services, performing the selected service with the received data on the first device based on the service instructions, wherein the selected service on the first device requires a user to be logged in with user service credentials different than the user login information.

15. The method of claim 14, wherein the available services on the first device are not available on the second device, and wherein the sending the service information comprises sending service information based on services not available on the other device.

16. The method of claim 14, wherein the method further comprises:
prior to performing the service on the first device, logging into the service on the first device with the received user service credentials without receiving further input from the user.

17. The method of claim 14, wherein the sending service information to the second device comprises sending the service information to the second device without further input from the user after sending the response message.

18. The method of claim 14, further comprising:
receiving, by the second device, the user login information from the user comprising the trusted device id associated with user;
sending, by the second device, a detection broadcast after the receiving the user login information by the second device, indicating the second device is associated with the trusted device id;
responsive to receiving a response message from the first device determined to be associated with the trusted device id, authenticating, by the second device, the trusted device id shared between the first and second devices to determine that the user has successfully logged into the first device with the user login information associated with the trusted device id; and
responsive to a positive authentication, receiving, by the second device, service information from the first device, wherein the service information comprises services available on the first device for use by the second device.

19. The method of claim 18, further comprising:
selecting a service among the available services; and
sending, by the second device, data and service instructions corresponding to the selected service, wherein the selected service is performed with the received data on the first device based on the service instructions, wherein the selected service on the first device requires a user to be logged in with user service credentials different than the user login information, and wherein the user service credentials are not stored on or received by the second device.

20. The method of claim 18, wherein the receiving service information from the first device comprises receiving the service information from the first device without further input from the user at the second device after sending the detection broadcast.

21. The method of claim 3, wherein the operations further provide:
responsive to detecting a broadcast from a third device associated with the trusted device id, sending a response message to the third device indicating the device is associated with the trusted device id;
mutually authenticating the trusted device id shared between the device and the third device to determine that the user has successfully logged into the third device with the user login information associated with the trusted device id and to provide authentication to the third device that the user has successfully logged into the device with the user information associated with the trusted device id;
performing the selected service for the third device with the same user service credentials as performing the selected service for the other device responsive to positive authentication that the user has successfully logged into each of the third device and the other device with the user login information associated with the trusted device id.

22. The method of claim 14, wherein the method further comprises:
responsive to detecting a broadcast from a third device associated with the trusted device id, sending a response message to the third device indicating the first device is associated with the trusted device id;
mutually authenticating the trusted device id shared between the first device and the third device to determine that the user has successfully logged into the third device with the user login information associated with the trusted device id and to provide authentication to the third device that the user has successfully logged into the first device with the user information associated with the trusted device id;
performing the selected service for the third device with the same user service credentials as performing the selected service for the second device responsive to positive authentication that the user has successfully logged into each of the third device and the second device with the user login information associated with the trusted device id.
